(19) United States
(12) Patent Application Publication
(10) Pub. No.: US 2012/0008632 A1
(43) Pub. Date: Jan. 12, 2012

(54) Sharing Resource Reservations Among Different Sessions In RSVP-TE

(75) Inventors: Hua Autumn Liu, Santa Clara, CA (US); Sriganesh Kini, Freemont, CA (US)

(73) Assignee: Telefonaktiebolaget L M Ericsson, Stockholm (SE)

(21) Appl. No.: 12/834,735

(22) Filed: Jul. 12, 2010

(51) Int. Cl. H04L 12/28

(52) U.S. Cl. 370/395.5

(57) ABSTRACT

A method to optimize resource allocation in a network employing MPL S, the method including the steps of communicating with a second node to establish a first LSP that includes a first node and the second node using an extension of RSVP-TE in a first RSVP-TE session having a group identifier. A resource controllable by the network element is allocated to the first LSP and is associated with the group identifier. The steps including communicating with a third node in the network to establish a second LSP that includes the first node and the third node using the extension of RSVP-TE through a second RSVP-TE session that is different than the first session and has the same group identifier. The resource is shared between the first LSP and the second LSP, because the same group identifier is associated with the first RSVP-TE session and second RSVP-TE session.

### FIELD OF THE INVENTION

Embodiments of the present invention relate to a system for managing resources over a network. Specifically, the embodiments of the invention relate to a method and system for optimizing the sharing of resources in a multi-protocol label switching network.

### BACKGROUND

Multi-protocol label switching (MPLS) is a technology utilized to manage traffic over a network. MPLS uses labels that are assigned to a stream of traffic to route the traffic across the network. Each node of the network supports MPLS by reviewing incoming traffic received over the network and forwarding that traffic based on its label.

MPLS networks with traffic engineering capabilities can optimize traffic engineering resource allocation for customized traffic services. In MPLS networks with traffic engineering, the primary label switch path (LSP) is set up for each customized traffic service. A back-up LSP for each customized traffic service is utilized in case of a failure of the primary LSP and is configured manually or by signaling. Each of the links in the back-up LSP is selected to construct a back-up LSP with a goal of creating a disjointed path that can be relied upon when the primary LSP is in a state of failure.

Resource reservation protocol (RSVP) is a protocol designed to reserve resources across a network. RSVP can be used by hosts or routers to request or deliver specific levels quality of service (QoS) for data traffic. RSVP reserves resources at each node along a path. A variant of RSVP, RSVP-traffic engineering (RSVP-TE) can be used to establish LSPs taking into account bandwidth and similar network resources.

### SUMMARY

A method performed in a network element to optimize resource allocation in a network employing Multi-Protocol Label Switching (MPLS) and reservation protocol-traffic engineering (RSVP-TE), wherein the network element is acting as a first node in the network, the method comprising the steps of: communicating with a second node in the network to establish a first label switch path (LSP) that includes the first node and the second node, wherein communicating includes using an extension of RSVP-TE, wherein the communicating to establish the first LSP is through a first RSVP-TE session having a first session object, wherein a resource share group object is included in the extension as part of establishing the first LSP, wherein a resource controllable by the network element is allocated to the first LSP and is associated with the resource share group object; and communicating with a third node in the network to establish a second LSP that includes the first node and the third node, wherein communicating includes using the extension of RSVP-TE, wherein the first LSP and the second LSP share at least one link, wherein the communicating is through a second RSVP-TE session having a second session object that is different than the first session object, wherein the resource share group object is included in the extension as part of establishing the second LSP, wherein the resource allocated to the first LSP is also allocated to the second LSP, and whereby the resource is shared between the first LSP and the second LSP even though they are established through different RSVP-TE sessions, because the extension includes the same resource share group object for both the first RSVP-TE session and second RSVP-TE session.

A network element to optimize resource allocation in a network employing Multi-protocol Label Switching (MPLS) and reservation protocol-traffic engineering (RSVP-TE), wherein the network element is configured to operate as one of a plurality of network elements in the network, the network element comprising an MPLS module is configured to process data traffic according to attached MPLS labels and established label switched paths (LPSs); and

an RSVP-TE module coupled to the MPLS module, the RSVP-TE module is configured to communicate with other network elements of the plurality of network elements to establish LSPs using an extension of RSVP-TE, wherein the extension includes a resource share group object to indicate LSPs whose establishment is through different RSVP-TE sessions, but that share resources where those LSPs traverse the same links;
and a resource allocation module coupled to the RSVP-TE module, the resource allocation module is configured to allocate in a shared manner the resources controllable by the network element according to the resource share group object of the different RSVP-TE sessions.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1A is a diagram of one embodiment of a network element implementing an optimized resource reservation protocol-traffic engineer (RSVP-TE) process.

FIG. 1B is a diagram of one embodiment of an example ring topology network employing the optimized RSVP-TE.

FIG. 2 is a flowchart of one embodiment of an optimized RSVP-TE.

FIG. 3 is a flowchart of one embodiment of a process for generating a RSVP-TE path message.

FIG. 4 is a flowchart of one embodiment of a process for generating a RSVP-TE reservation message.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

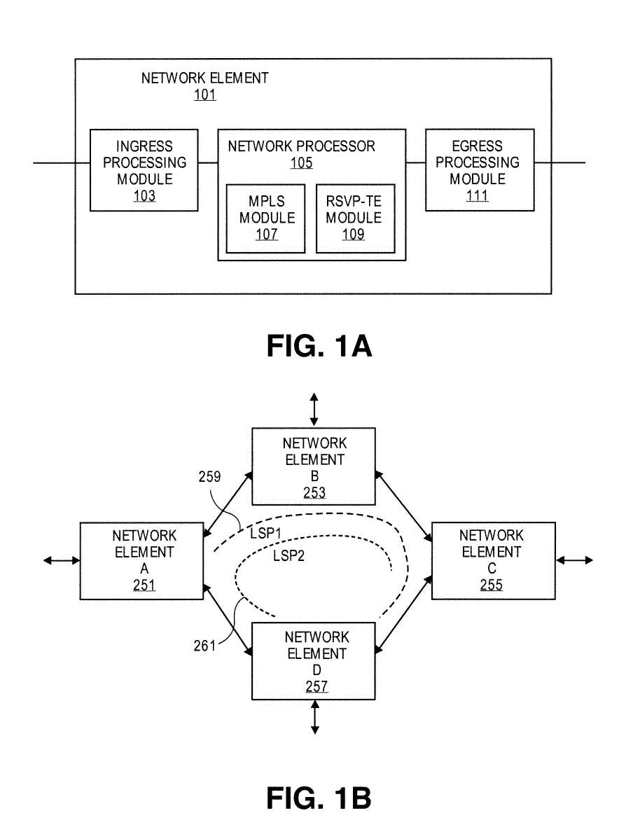

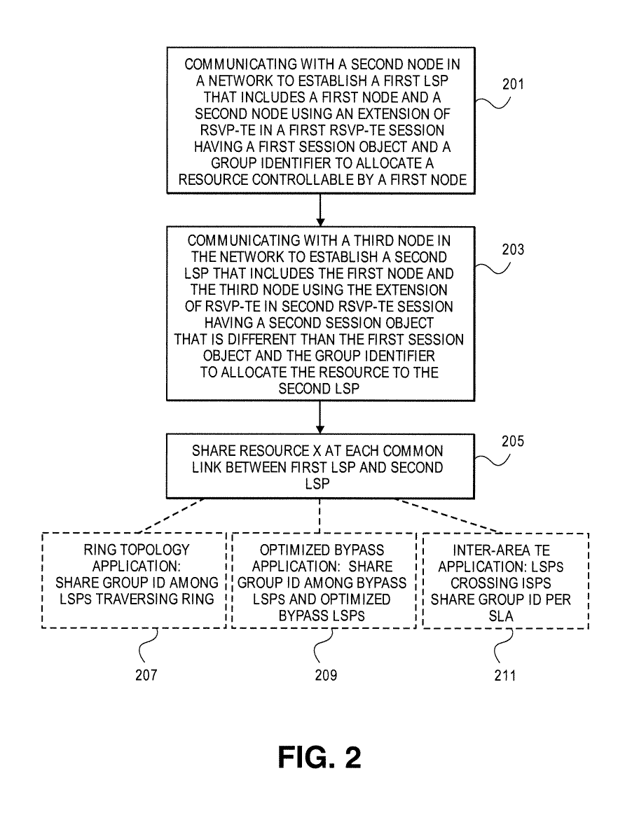

The operations of the flow diagrams will be described with reference to the exemplary embodiment of FIGS. 1A and 1B. However, it should be understood that the operations of the flow diagrams can be performed by embodiments of the invention other than those discussed with reference to FIGS. 1A and 1B, and the embodiments discussed with reference to FIGS. 1A and 1B can perform operations different than those discussed with reference to the flow diagrams of FIGS. 2-4.

The techniques shown in the figures can be implemented using code and data stored and executed on one or more electronic devices (e.g., a host, a router, a network element, etc.). Such electronic devices store and communicate (internally and/or with other electronic devices over a network) code and data using non-transitory tangible machine-readable or computer-readable media, such as non-transitory tangible machine-readable or computer-readable storage media (e.g., magnetic disks, optical disks, random access memory, read only memory, flash memory devices, and phase-change memory). In addition, such electronic devices typically include a set of one or more processors coupled to one or more other components, such as one or more storage devices, user input/output devices (e.g., a keyboard, a touch screen, and/or a display), and network connections. The coupling of the set of processors and other components is typically through one or more busses and bridges (also termed as bus controllers). The storage device and signals carrying the network traffic respectively represent one or more non-transitory tangible machine-readable or computer-readable storage media and non-transitory tangible machine-readable or computer-readable communication media. Thus, the storage device of a given electronic device typically stores code and data for execution on the set of one or more processors of that electronic device. Of course, one or more parts of an embodiment of the invention may be implemented using different combinations of software, firmware, and/or hardware.

As used herein, a network element (e.g., a router, switch, bridge, etc.) is a piece of networking equipment, including hardware and software, that communicatively interconnects other equipment on the network (e.g., other network elements, end stations, etc.). Some network elements are “multiple services network elements” that provide support for multiple networking functions (e.g., routing, bridging, switching, Layer 2 aggregation, session border control, multicasting, and/or subscriber management), and/or provide support for multiple application services (e.g., data, voice, and video). Subscriber end stations (e.g., servers, workstations, laptops, palm tops, mobile phones, smart phones, multimedia phones, Voice Over Internet Protocol (VOID) phones, portable media players, GPS units, gaming systems, set-top boxes (STBs), etc.) access content/services provided over the Internet and/or content/services provided on virtual private networks (VPNs) overlaid on the Internet. The content and/or services are typically provided by one or more end stations (e.g., server end stations) belonging to a service or content provider or end stations participating in a peer to peer service, and may include public web pages (free content, store fronts, search services, etc.), private web pages (e.g., username/password accessed web pages providing email services, etc.), corporate networks over VPNs, IPTV, etc. Typically, subscriber end stations are coupled (e.g., through customer premise equipment coupled to an access network (wired or wirelessly) to edge network elements, which are coupled (e.g., through one or more core network elements to other edge network elements) to other end stations (e.g., server end stations).

The embodiments of the present invention provide a system, network and method for avoiding the disadvantages of the prior art including: resource sharing being restricted to within sessions resulting in higher bandwidth requirements and inefficient bandwidth utilization.

The embodiments of the invention overcome these disadvantages by enabling sharing of resources across sessions such that each network element shared between label switch paths (LSPs) with common group object will share resources associated with the group object. This process is enabled by establishing a group object in the reservation and path messages of the reservation protocol. By using the group object, each of the nodes in a multi-protocol label switching (MPLS) network can identify those LSPs that can share a resource associated with the group object even when the LSPs do not share a session object. This reduces the bandwidth requirements on many of the links and separate resource allocations do not need to be made for each of the LSPs in the group when these LSPs traverse common links. In turn, this increases the amount of bandwidth available at each node and thereby improves the operation of the node by making the resources better utilized and having a higher availability.

FIG. 1A is a diagram of one embodiment of a network element implementing the optimized resource reservation protocol traffic engineering (RSVP-TE). In one embodiment, the network element 101 includes a network processor 105, an ingress processing module 103 and an egress processing module 111. The ingress processing module 103 and the egress processing module 111 handle the processing of data traffic at the data link layer and the physical link layer. The ingress processing module 103 and egress processing module 111 can handle some or all of the processing of the incoming and outgoing packets of the physical layer, data link layer, and other layers of the open system interconnect (OSI) reference model below the multi-protocol label switching (MPLS) layer.

The network processor 105 can implement or execute an MPLS module 107 and a resource reservation protocol-traffic engineering (RSVP-TE) module 109. The network processor 105 is responsible for implementing the processing of MPLS layer functionality. The MPLS layer functionality can be implemented in the MPLS module 107. The RSVP-TE module 109 is used in conjunction with the MPLS module 107 to establish label switch paths (LSPs) and to reserve resources for each of these LSPs. In addition, the RSVP-TE module 109 can be used to identify groupings of LSPs for the sharing of resources amongst the grouped LSPs irrespective of the session or instance of the LSPs with the group. LSPs having different sessions have different source and destination nodes. The RSVP-TE module 109 extends the standard RSVP-TE as defined in RFC 3209 by defining a reservation share object that is incorporated into path messages and reservation messages to coordinate the sharing of resources across the links and nodes of an LSP. As used herein, ‘nodes’ can be network elements or similar devices within a network. The extended version of RSVP-TE may be referred to herein as an optimized RSVP-TE.

FIG. 1B is a diagram of one example embodiment of a system implementing an optimized RSVP-TE. The network includes a Network Element A 251, Network Element B 253, Network Element C 255 and Network Element D 257. Any number or combination of these network elements can implement the optimized RSVP-TE. In one example embodiment, the Network Element A can establish LSP1 259 originating at the Network Element A 251 and ending at Network Element D 257. The Network Element A 251 would establish LSP1 by sending out a path message to Network Element B 253 that would in turn pass on the path message to Network Element C 255 and ultimately reach Network Element D 257. In one example embodiment, a network a ring architecture is utilized as shown in FIG. 1B. However, this protocol enhancement of RSVP-TE is equally applicable to any type of network topology.

In response to receiving the path message, Network Element D 257 sends a reservation message back through Network Element C 255, Network Element B 253 and returning to Network Element A 251. Both the path message and the reservation message would include a reservation share object that would include a group ID or name for the LSP1 259. The path and reservation messages would also identify any resource to be allotted to the LSP 259, such as bandwidth or similar node or link resources.

A second LSP2 261 can be established by Network Element D 257 by sending out a path message through Network Element A 251, Network Element B 253 and Network Element C 255. The LSP2 261 can also be designated as having the same group object even though LSP1 and LSP2 are separate sessions and they have different start and end nodes. LSP1 259 and LSP2 261 still share links between Network Elements A251 and B 253 and Network Elements B 253 and C 255. For these links at Network Elements A 251, B 253 and C 255, traffic resources can be shared between LSP1 259 and LSP2 261. In this way, the network administrator can more accurately allocate resources and maintain resource availability. To do this, both LSP1 259 and LSP2 261 are established utilizing the same group object. Each of the network elements that implement the optimized RSVP-TE protocol can use this information to manage the resources associated with the group object such that they are shared between the first LSP1 259 and the second LSP 261. Any number of groups of LSPs can be utilized to manage any number of associated resources. Resource sharing can be implemented using any resource sharing algorithm or program. When a new LSP is established that traverses a link that an existing LSP already traverses and establishes a resource reservation, a check is made to determine if the existing LSP and the new LSP belong to the same resource share group. If the existing LSP and the new LSP are a part of the same resource share group, then no new resource reservation is established. The new LSP is added to the sharing list of the reserved resource. As a result, bandwidth is not increased (i.e., there is no double reservation). If the new and existing LSPs belong to different resource share groups, then new resource is reserved for the new LSP.

FIG. 2 is a flowchart of one embodiment of the optimized RSVP-TE process. In one embodiment, the process can be initiated by establishing a first LSP using RSVP-TE, where the first LSP has a first session object and a first group object and where at least one resource is allocated to the first LSP. In this manner, the reservation share object in the reservation and path messages are utilized to pass the group ID or group name to each of the nodes in the first LSP. Each of the nodes of the LSP communicate with one another, specifically the adjacent nodes, within a first RSVP-TE session having a first RSVP-TE session object. The communication identifies at least one resource that is controllable by at least one node in the LSP and associates it with the group object (Block 201).

At any time after the establishment of the first LSP, a second LSP can be established through a second RSVP-TE session utilizing a second session object, but the first group object (Block 203). By using the same group object, the network administrator can indicate that the resources allotted to the first LSP should be shared with the second LSP. The group object is promulgated through each LSP through the use of path messages and reservation messages (resource requirements are separately signaled). Each of the nodes that are shared between the first LSP and the second LSP can share the resources associated with the group object.

There are several applications of this optimized RSVP-TE that exemplify the scope and utility of the optimized RSVP-TE. In one example embodiment, in a ring topology, any number of LSPs can be established for protection switch purposes or other similar tunneling purposes (Block 207). In the ring topology, these LSPs will likely have a great deal of overlap. Thus, it is more efficient to allot resources such as bandwidth to be shared amongst the LSPs. This can be accomplished using a common group object for each LSP in a ring topology so the resources controllable by the nodes in the ring topology can be shared by all of the LSPs.

In another example application, a network architecture makes use of optimized bypass LSPs. Bypass LSPs are used in case of failure of a link to re-route traffic and can be used in conjunction with an optimized bypass LSPs. An optimized bypass LSP can be determined that eliminates redundant links in an associated parent bypass LSP. Since either the bypass LSP or the optimized bypass LSP will be used in any given situation, it is more efficient to share the resources between the bypass LSP and the optimized bypass LSP, which can be accomplished through the use of a shared group object (Block 209).

In another example application, the network architecture can include inter-area traffic engineering such as a set of LSPs that traverse multiple networks controlled by separate Internet Service Providers ISPs. These ISPs can have a service level agreement (SLA) that covers the resources that link these networks or the traffic from one network that crosses the other network. The LSPs that are inter-area can be governed by the SLAs by use of a group object associated with an SLA such that the resources are shared and the SLA can be adhered to (Block 211).

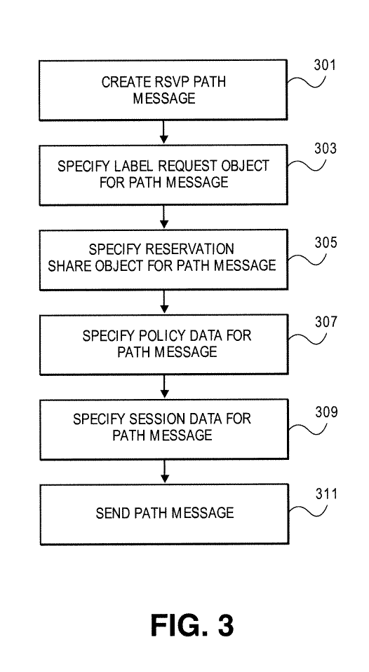

FIG. 3 is flowchart of one embodiment of a process for generating an RSVP path message such as an RSVP path message that would be used to set up a LSP using RSVP-TE. This process can be initiated by the creation of the RSVP path message (Block 301). The fields of the path message would be further defined by specifying a label request object in the path message (Block 303). The label request object indicates that there is a need to allocate a label and it provides a range from which a label can be drawn and be associated with the LSP that is to be set up by the path message. The reservation share object is also specified or defined for the path message (Block 305). The reservation share object defines the group ID and similar data that can be used to group the LSP being established by this path message with other LSPs that may already exist so that the specified resources can be shared between them. A SENDER_TSPEC object specifies the bandwidth requirement associated with the LSP and is carried in the path message (Block 307).

A SESSION object can be set for the path message (Block 309). The completed message can then be sent along the path toward the destination address (Block 311). An example path message organization is set forth below.

| | |
|---|---|
| <Path Message> ::= | <Common Header> [ <INTEGRITY> ] |

<SESSION> <RSVP_HOP>
<TIME_VALUES>
[ <EXPLICIT_ROUTE> ]
<LABEL_REQUEST>
[ <SESSION_ATTRIBUTE> ]
[ <POLICY_DATA> ...]
[ <RESERVATION_SHARE> ]
<sender descriptor>

In one example embodiment, the resource share object can have the following format:

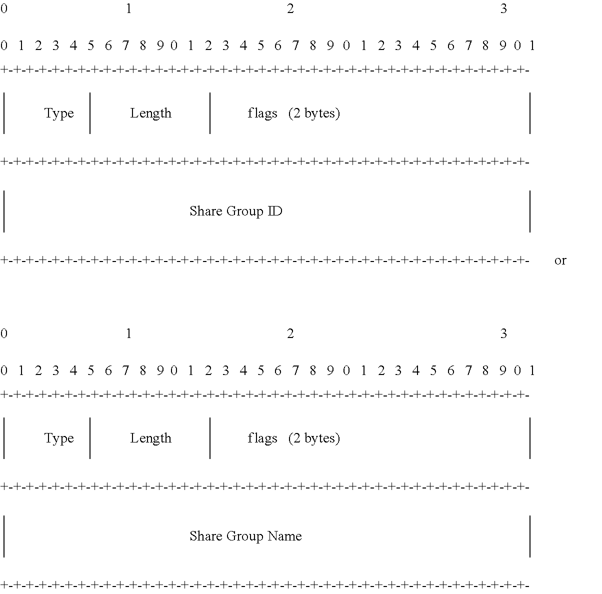

depending on whether the group ID is a numeric identifier or a string or similar alphanumeric group name.

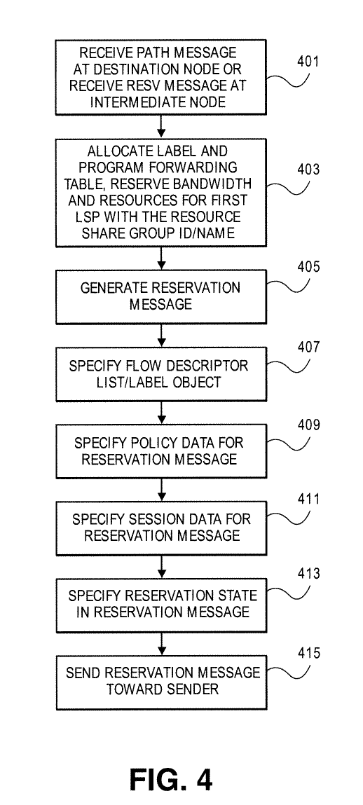

FIG. 4 is a flowchart of one embodiment of a process for responding to a path message with a reservation message. This process can be initiated in response to receiving a path message at a destination node or a reservation message at an intermediate node (Block 401). The label switching data and similar routing data is updated by each node to establish the LSP defined by the incoming path message (Block 403). Then a reservation message is generated (Block 405). A reservation message is further completed by specifying a label object as part of the flow descriptor (Block 407). SESSION object for the reservation message is defined (Block 411).

A reservation style is also defined (Block 413). The reservation styles can include wildcard style, the shared explicit style or the fixed filter style or similar styles that are defined by RSVP-TE. In one embodiment, the shared explicit style is augmented to include the resource shared object. The reservation message is then forwarded toward the originating node back along the LSP that has been defined by the received path message (Block 415). Each recipient along the route allocates label, updates its forwarding table and make resource reservation shared if the LSP belongs to the same resource share group and forwards the reservation message towards the originating node.

In one embodiment the reservation message has the following format:

| | |
|---|---|
| <Resv Message> ::= | <Common Header> [ <INTEGRITY> ] |

<SESSION> <RSVP_HOP>

<TIME_VALUES>
[ <RESV_CONFIRM> ]
[ <SCOPE> ]
[ <POLICY_DATA> ...]

[ <RESERVATION_SHARE> ]
<STYLE>
<flow descriptor list>

Thus, a method, system and apparatus for optimized RSVP-TE has been described. It is to be understood that the above description is intended to be illustrative and not restrictive. Many other embodiments will be apparent to those of skill in the art upon reading and understanding the above description. The scope of the invention should therefore be determined with reference to the appended claims, along with the full scope of equivalence to which such claims are entitled.

What is claimed is:

1. A method performed in a network element to optimize resource allocation in a network employing Multi-Protocol Label Switching (MPLS), wherein the network element is acting as a first node in the network, the method comprising the steps of:
communicating with a second node in the network to establish a first label switch path (LSP) that includes the first node and the second node, wherein communicating includes using an extension of resource reservation protocol-traffic engineering (RSVP-TE), wherein the communicating to establish the first LSP is through a first RSVP-TE session having a first session object, wherein a group object is included in the extension as part of establishing the first LSP, wherein a resource controllable by the network element is allocated to the first LSP and is associated with the group object; and
communicating with a third node in the network to establish a second LSP that includes the first node and the third node, wherein communicating includes using the extension of RSVP-TE, wherein the first LSP and the second LSP share at least one link, wherein the communicating is through a second RSVP-TE session having a second session object that is different than the first session object, wherein the group object is included in the extension as part of establishing the second LSP, wherein the resource allocated to the first LSP is also allocated to the second LSP, and
whereby the resource is shared between the first LSP and the second LSP even though they are established through different RSVP-TE sessions, because the extension includes the same group object for both the first RSVP-TE session and second RSVP-TE session.

2. The method of claim 1, wherein the network has a ring topology that is traversed by the first LSP and the second LSP, and
wherein the network element is within the ring topology.

3. The method of claim 1, wherein the first LSP is a bypass LSP and the second LSP is an optimized bypass LSP.

4. The method of claim 1, wherein the network traversed by the first LSP and the second LSP includes an area of a first internet service provider (ISP) and an area of a second ISP, and
wherein the resource shared by the first LSP and second LSP is constrained by a service level agreement between the first ISP and the second ISP.

5. The method of claim 1, wherein the step of communicating with the second node comprises the further steps of:
creating an RSVP-TE path message;
specifying a label request object for the path message;
specifying as the extension a reservation share object including the group identifier for the path message;
specifying a traffic descriptor for the path message;
specifying the first session object for the path message; and
sending the path message to the second node.

6. The method of claim 1, further comprising:
communicating with a fourth node to establish the first LSP that includes the first node, the second node and the fourth node, wherein the step of communicating with the fourth node comprises:
creating an RSVP-TE reservation message;
specifying a label object for the reservation message;
specifying as the extension a reservation share object including the group object for the reservation message;
specifying policy data for the reservation message;
specifying the first session object for the reservation message;
specifying a reservation style for the reservation message; and
sending the reservation message to the fourth node.

7. A network element to optimize resource allocation in a network employing Multi-protocol Label Switching (MPLS), wherein the network element is configured to operate as one of a plurality of network elements in the network, the network element comprising:
an MPLS module is configured to process data traffic according to attached MPLS labels and established label switched paths (LPSs); and
an RSVP-TE module coupled to the MPLS module, the RSVP-TE module is configured to communicate with other network elements of the plurality of network elements to establish LSPs using an extension of resource reservation protocol-traffic engineering (RSVP-TE), wherein the extension includes a group identifier field to indicate LSPs whose establishment is through different RSVP-TE sessions, but that share resources where those LSPs overlap; and
a resource allocation module coupled to the RSVP-TE module, the resource allocation module is configured to allocate in a shared manner the resources controllable by the network element according to the group object of the different RSVP-TE sessions.

8. The network element of claim 7, wherein the MPLS module is configured to process data traffic of bypass LSPs and to process data traffic of optimized bypass LSPs such that bandwidth can be shared along the shared links.

9. The network element of claim 7, wherein the network traversed by the LSPs includes an area of a first internet service provider (ISP) and an area of a second ISP, and
wherein the resources shared by the LSPs are constrained by a service level agreement between the first ISP and the second ISP, and
wherein the service level agreement constraint is implemented by associating the resources constrained by the service level agreement with a group identifier.

10. The network element of claim 7, wherein the RSVP-TE module is configured to establishes an LSP by creating an RSVP-TE path message, wherein the path message includes a label request object, a reservation share object including the group identifier or name for the path message, a policy data field, and a session object field.

11. The network element of claim 7, wherein the RSVP-TE module is configured to establish an LSP by creating an RSVP-TE reservation message, wherein the reservation message includes a label object, a reservation share object including the group identifier or group name, policy data field, a session object field, and a reservation style field.
